(19) United States
(12) Patent Application Publication
(10) Pub. No.: US 2021/0083711 A1
(43) Pub. Date: Mar. 18, 2021

(54) Adapter Phone Case

(71) Applicant: Larry Donnell Miles, JR., Temple Hills, MD (US)

(72) Inventor: Larry Donnell Miles, JR., Temple Hills, MD (US)

(21) Appl. No.: 16/920,364

(22) Filed: Jul. 2, 2020

Related U.S. Application Data
(60) Provisional application No. 62/973,089, filed on Sep. 18, 2019.

(51) Int. Cl. H04B 1/3888; H04M 1/02

(52) U.S. Cl. CPC H04B 1/3888; H04M 1/0279; H04M 1/026

(57) ABSTRACT

The invention relates to providing protection to cell phone as well as provide a compartment or pocket located on the back of the case where a headphone jack adapter can be stored and covered in place. The compartment or pocket is covered by a rubber or plastic tab.

### CROSS-REFERENCE TO RELATED APPLICATIONS

Cell Phone Case

### STATEMENT REGARDING FEDERALLY SPONSORED RESEARCH OR DEVELOPMENT

### The Names of the Parties to a Joint Research Agreement

N/A

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

N/A

### STATEMENT REGARDING PRIOR DISCLOSURES BY THE INVENTOR OR A JOINT INVENTOR

N/A

### BACKGROUND OF THE INVENTION

### (1) Field of the Invention: Cell Phone Case

### (2) DESCRIPTION OF RELATED ART INCLUDING INFORMATION DISCLOSED UNDER 37 CFR 1.97 AND 1.98

N/A

### BRIEF SUMMARY OF THE INVENTION

Cell Phone protective case designed for Iphone models. The backside of the cell phone case has a compartment which allows the headphone jack adapter to be clipped and stored in place. The compartment is covered by a removable tab.

### BRIEF DESCRIPTION OF THE SEVERAL VIEWS OF THE DRAWING(S)

FIGS. 1 and 2 shows: cell phone case from the backside, displaying the compartment with the headphone jack adapter stored in place. The removable tab shifted to the side, showing how the compartment can be covered and open.

FIG. 3 show the front of the cell case. Standard open space for Iphone to be placed within case protecting the frame of the phone.

FIG. 4 shows left side of phone case with volume up and down buttons

FIG. 5 shows right side of phone case with power button

FIG. 6 shows top of phone case

FIG. 7 shows bottom of phone case with open slots for charging port and speakers.

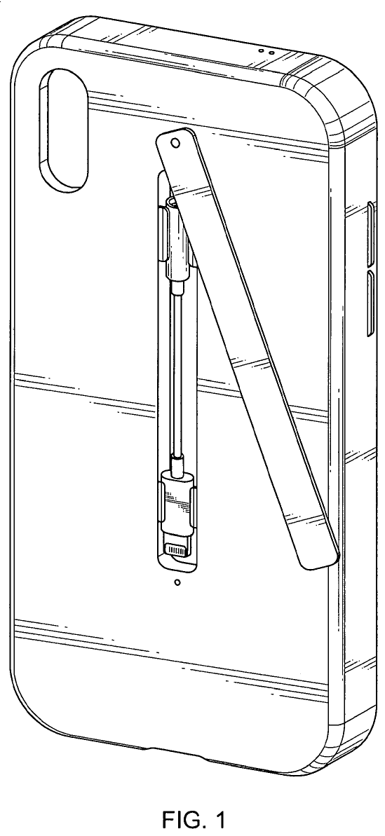

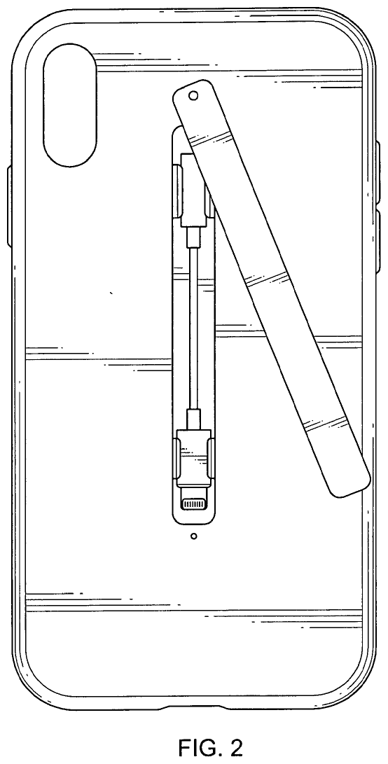

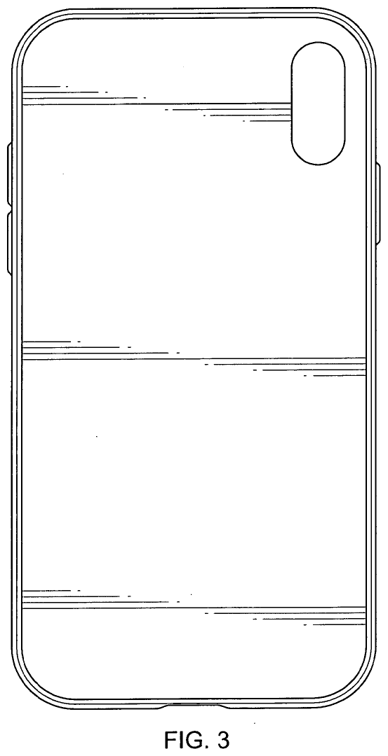

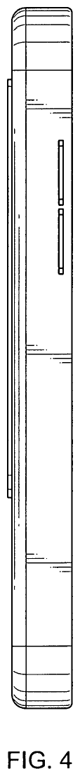

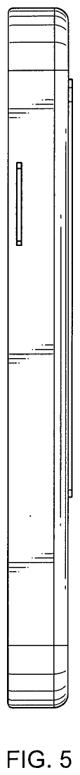

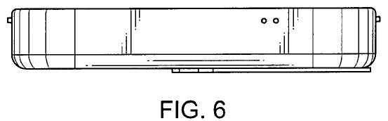

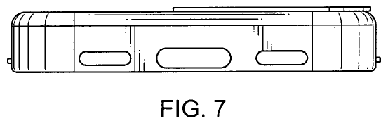

### DETAILED DESCRIPTION OF THE INVENTION

Cell phone case designed for Iphone model phones. The case is designed to protect the body of the cell phone as well as store the headphone jack adapter on the backside of the case. The compartment on the back of the case allows the adapter to clip and stay in place. The compartment has a cover tab piece which allows the adapter to be covered and protected while in place.

1. A case for a cellular phone, wherein the case comprises:
(a) A compartment or pocket integrated on the back of the phone case allowing a headphone jack adapter to be held in place
(b) A space located in the compartment and adapted with holding brackets to hold headphone jack adapter.

2. A case for cellular phone according to claim 1, characterized in that the compartment or pocket, where the headphone jack adapter is held, is covered by an rubber or plastic strap covering the headphone jack adapter in place and avoiding the casual displacement thereof.
